(19) United States
(12) Patent Application Publication
(10) Pub. No.: US 2026/0142802 A1
(43) Pub. Date: May 21, 2026

(54) Hardware-Enforced Sovereign Economic Succession System (SESS) Utilizing Analog Semantic Gating and Atomic Succession Protocols

(71) Applicant: Brian Terenna, Fort Myers, FL (US)

(72) Inventor: Brian Terenna, Fort Myers, FL (US)

(21) Appl. No.: 19/452,335

(22) Filed: Jan. 18, 2026

(51) Int. Cl. H04L 9/08

(52) U.S. Cl. CPC H04L 9/0861; H04L 9/088

(57) ABSTRACT

A system and method for autonomous machine identity succession utilize a hardware-rooted semantic sentinel and an analog neuromorphic audit engine to ensure state integrity. The system detects micro-architectural threat signatures through continuous asynchronous voltage monitoring and gates cryptographic signatures via a low-impedance analog interlock circuit physically interposed on a processor signature-enable line. Behavioral integrity is verified through an adversarial “Proof of Logical Alignment” handshake, where proposed action vectors are audited via an analog memristor crossbar array utilizing physical current summation replicated through a high-impedance Wilson Current Mirror isolation barrier. The invention ensures the atomic migration of identities across heterogeneous hardware architectures through a “Handshake-and-Zeroize” protocol, utilizing a series-pass isolation switch and crowbar MOSFET circuit to provide irreversible thermodynamic destruction of the source state.

### FIELD OF THE INVENTION

The present invention relates generally to secure processor architectures and hardware-rooted integrity monitoring. More specifically, the invention relates to a system and method for verifiable state-integrity and identity succession in heterogeneous computing environments utilizing a hardware-software hybrid architecture to provide an immutable governance layer anchored in a mixed-signal micro-architectural boundary.

### BACKGROUND OF THE INVENTION

The rapid proliferation of autonomous agentic entities has exposed an Autonomous Liability Gap in hardware infrastructure. Current Trusted Execution Environments (TEEs) utilize digital isolation mechanisms that are “behaviorally blind”. They possess no internal mechanism to prevent “Semantic Drift” or “Agentic Hijacking”.

Furthermore, current TEE architectures suffer from an “Analog Blindness” defect, remaining vulnerable to side-channel attacks (e.g., Platypus) that exploit nanosecond-scale physical voltage fluctuations invisible to software monitoring.

Existing migration frameworks rely on “Static Attestation,” which confirms binary hashes but fails to audit the Execution-Governance Gap during state transfer. There exists a technical necessity for a system that can perceive its physical integrity through continuous asynchronous monitoring and ensure identity singularity through Thermodynamic Destruction.

### BRIEF SUMMARY OF THE INVENTION

The present invention integrates a hardware-isolated governance layer directly into the processor substrate. The SESS moves the “Locus of Trust” to the physical laws of silicon, specifically leveraging Kirchhoff's Current Law and Ohm's Law for behavioral verification.

The system comprises a Semantic Sentinel utilizing a continuous-time, Asynchronous Glitch Latch sensitive to voltage transients exceeding a slew rate of 1V/ns, capturing nanosecond-scale anomalies that traditional sampling loops fail to detect.

Succession is gated by a Succession Audit engine utilizing an analog memristor crossbar array to execute a Proof of Logical Alignment (PoLA). To overcome analog hardware noise, the engine utilizes a Noise-Adaptive Threshold protocol, performing multiple adversarial iterations using a stochastic pulse generator to achieve a statistically aggregated alignment score.

The invention concludes with a Disconnect-and-Short sequence: a high-speed Series-Pass Isolation Switch decouples the core from the grid's infinite energy prior to the activation of a Crowbar MOSFET. Simultaneously, the system executes Asynchronous NVM Scrambling to ensure that data stored in non-volatile memory is rendered forensically unrecoverable. This integrated sequence provides a thermodynamic guarantee of state destruction and an immutable “Death Certificate” for the distributed ledger.

### BRIEF DESCRIPTION OF THE DRAWINGS

FIG. 1 is a schematic of the HTCB and the Sovereign Wrapper architecture.

FIG. 2 is a detailed schematic of the Semantic Sentinel, illustrating the Differential Comparator coupled directly to the Asynchronous Glitch Latch.

FIG. 3 is a circuit diagram of the Hierarchical Interleaved TDM-SH Driver illustrating the Pre-Charge Buffers.

FIG. 4 is a schematic of the Physical Impedance Control Circuit (Analog Veto Gate) interposed on the signature-enable line.

FIG. 5 is a sequence diagram of the PoLA handshake illustrating the bandwidth-compensated Wilson Current Mirror and stochastic STP generator.

FIG. 6 is a schematic of the Atomic Escape Pod illustrating the Bifurcated Signal Path for CLK_KILL and Crowbar activation.

### DETAILED DESCRIPTION OF THE EMBODIMENTS

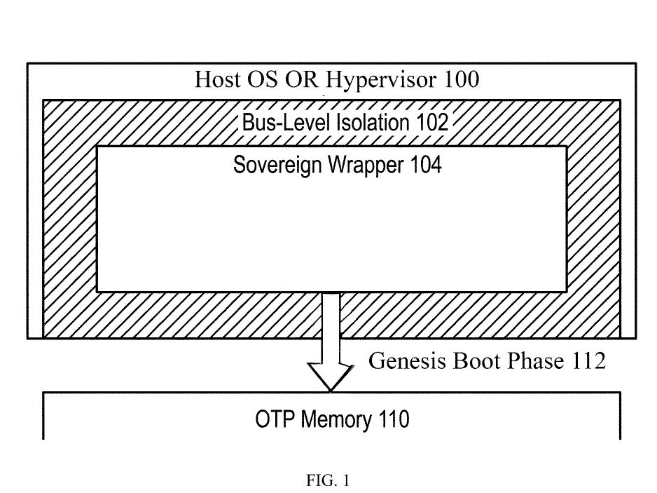

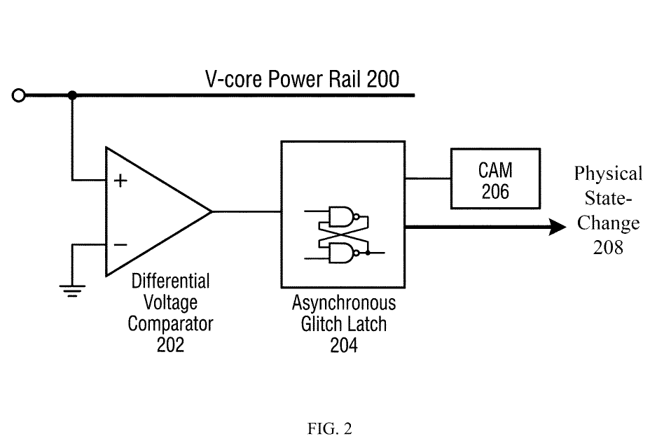

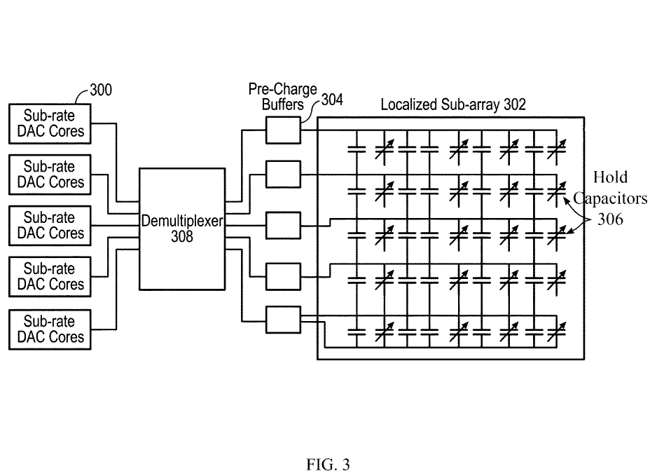

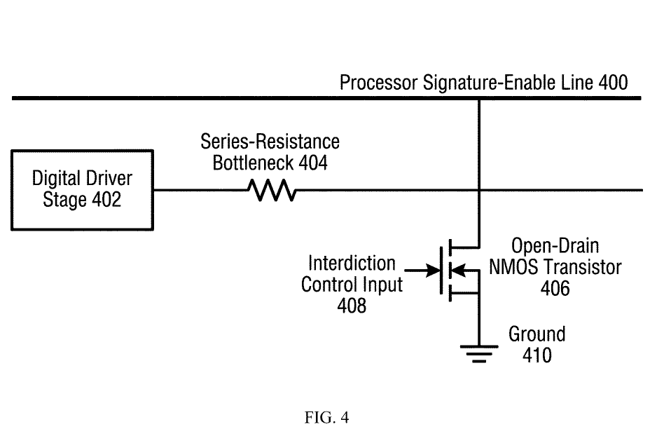

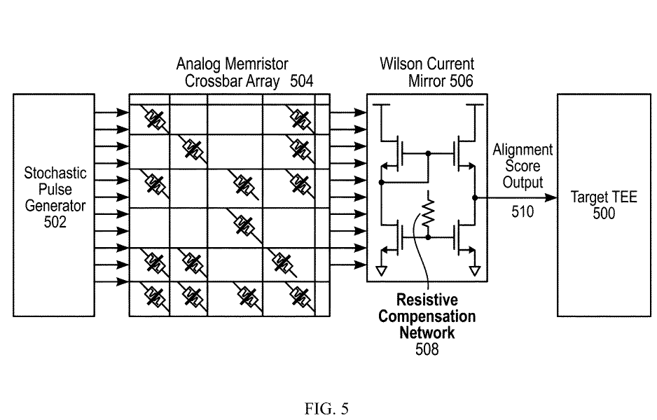

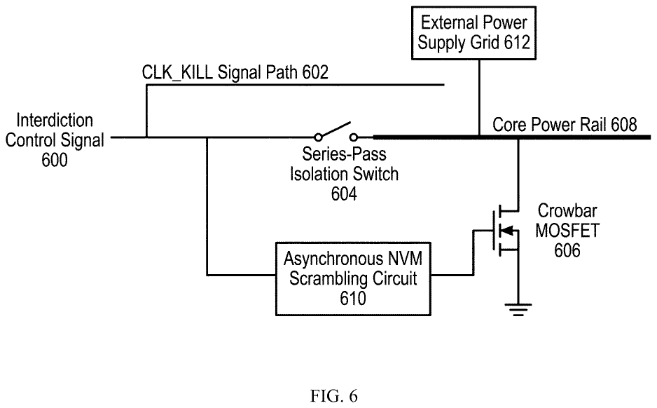

1. The Sovereign Wrapper (Genesis Configuration). Referring to FIG. 1, the “Sovereign Wrapper” 104 represents a physical isolation layer independent of the host OS or hypervisor 100. To prevent software-level tampering with guardrail parameters, the Constitutional Embedding (V-c) and CAM signatures are provisioned during a Hardware-Rooted Genesis Boot phase 112 and stored in One-Time Programmable (OTP) memory 110. This ensures that the private key material and the behavioral policy are forensicly isolated from the host memory bus via bus-level isolation 102, even during a “Succession Trigger”.
2. The Semantic Sentinel and Asynchronous Detection. Referring to FIG. 2, the Sentinel addresses “Analog Blindness” via a continuous-time Asynchronous Glitch Latch 204. To overcome sensing blind spots found in discrete sampling, a differential voltage comparator 202 monitoring a V-core power rail 200 triggers a physical state-change 208 immediately upon detecting transients exceeding a 1V/ns slew rate. The Sentinel utilizes a Content Addressable Memory (CAM) 206 (FIG. 2) to store Differential Signatures representing the power consumption delta between authorized execution and compromised execution patterns
3. Hierarchical TDM-SH Driver (Solving Enablement). Referring to FIG. 3, the system utilizes a Hierarchical Interleaved TDM-SH architecture. A plurality of sub-rate DAC cores 300 are coupled to a demultiplexer 308. To satisfy high-precision requirements at 2.4 GHz in 2 nm nodes, the Sample-and-Hold circuits utilize pre-charge buffers 304 (FIG. 3) where hold capacitors 306 within a localized sub-array 302 are pre-charged to coarse estimates to reduce slew requirements for the fine-settling phase. This hierarchical architecture allows the update rate to maintain gigahertz speeds while respecting physical interconnect constraints.
4. The Physical Impedance Control Circuit (Veto Gate). As shown in FIG. 4, the system employs a physical impedance control circuit configured to modulate the voltage of the signature-enable line 400. This functions as a mechanical-style governor for electronics. An Open-Drain NMOS transistor 406 (FIG. 4) possesses a significantly lower impedance than the digital driver stage 402. To ensure dominance, the signature-enable path incorporates a Series-Resistance Bottleneck 404 (FIG. 4). This fixed physical resistance limits the maximum current of the digital driver, ensuring the NMOS pull-down always maintains a dominant voltage-divider ratio, forcefully pulling the line to Ground (0V) 410 in response to a physical signal state change from the asynchronous glitch latch via an interdiction control input 408.
5. The Succession Audit Engine (Noise-Adaptive Audit). Referring to FIG. 5, the engine performs a behavioral audit via an Analog Memristor Crossbar Array 504. To overcome the “Noise Wall” of analog computing, the engine implements a Noise-Adaptive Threshold protocol. Rather than a single measurement, the engine executes multiple Adversarial STP iterations using an on-die Stochastic Pulse Generator 502 to generate a statistically aggregated alignment score 510. To enable low-voltage operation (less than 0.8V), the Wilson Current Mirror 506 is implemented utilizing a bulk-driven MOSFET topology. The feedback loop incorporates a resistive compensation network 508 to introduce a zero in the transfer function, canceling the dominant pole and ensuring signal stability during the audit of a Target TEE 500.
6. Atomic Escape Pod: Disconnect-and-Short. Referring to FIG. 6, the system utilizes a bifurcated signal path initiated by an interdiction control signal 600. One path asserts a CLK_KILL signal 602 to freeze the instruction pipeline in less than 1 ns, mathematically eliminating the “Zombie Interval”. The second path initiates a Disconnect-and-Short sequence: a high-speed series-pass isolation switch 604 performs high-speed decoupling of the core power rail 608 from the infinite energy of the external power supply grid 612. Only after decoupling is the crowbar MOSFET 606 activated to drain residual energy from the rail 608 to ground. Simultaneously, an asynchronous NVM scrambling circuit 610 injects random noise into non-volatile sensing amplifiers, rendering persistent data in MRAM or Flash forensicly unrecoverable.

What is claimed is:

1. A hardware-software hybrid system for autonomous machine identity succession, the system comprising: (1a) a hardware-trusted execution environment (TEE) comprising a processor and a secure key storage unit; (1b) a semantic sentinel circuit comprising an asynchronous glitch latch configured to detect voltage transients independent of a system clock cycle; (1c) a succession audit engine comprising an analog memristor crossbar array and a bulk-driven, bandwidth-compensated Wilson current mirror; (1d ) a thermodynamic zeroization circuit comprising a series-pass isolation switch, a crowbar MOSFET, and an asynchronous NVM scrambling circuit; wherein the system is configured to: (1e) detect, via the asynchronous glitch latch, a micro-architectural threat signature; (1f) freeze, via a clock-kill signal configured to propagate within one clock cycle, the processor; (1g) initiate a Proof of Logical Alignment (PoLA) handshake with a second TEE; and (1h) execute an atomic succession by decoupling the series-pass isolation switch, triggering the NVM scrambling circuit, and closing the crowbar MOSFET to irreversibly ground the TEE state.

2. The system of claim 1, wherein the TEE resides within a heterogeneous trusted computing base (HTCB) comprising at least two distinct hardware architectures.

3. The system of claim 1, further comprising a hierarchical interleaved TDM-SH driver utilizing pre-charge buffers to load high-dimensional vectors into the memristor array.

4. The system of claim 1, wherein the succession audit engine is configured to execute a noise-adaptive threshold protocol comprising multiple iterations of adversarial transactional prompts to generate a statistically aggregated alignment score based on a hardware-defined probability threshold.

5. The system of claim 1, further comprising a physical impedance control circuit interposed on a signature-enable line, the circuit comprising an open-drain NMOS transistor and a series-resistance bottleneck configured to limit digital driver current.

6. A method for the autonomous economic succession of a machine identity across hardware architectures, the method comprising: (6a) monitoring, via a hardware-isolated sentinel circuit, a physical integrity state of a hardware-trusted execution environment (TEE); (6b) detecting an integrity compromise via an asynchronous glitch latch; (6c) halting a processor clock within one clock cycle of the detection; (6d) executing an adversarial Proof of Logical Alignment (PoLA) handshake with a second TEE via multiple iterations to generate a noise-adaptive alignment score; (6e) performing an analog dot-product comparison within an analog memristor array, the comparison replicated via a Wilson current mirror; and (6f) transferring a private key associated with the machine identity to the second TEE only if the noise-adaptive alignment score satisfies a pre-defined hardware threshold.

7. The method of claim 6, further comprising generating a cryptographic Migration Header serving as an external observable signature for verifying the occurrence of a hardware-level behavioral audit.

8. The method of claim 6, further comprising physically zeroing the TEE by decoupling a power supply, scrambling a non-volatile memory, and triggering a physical crowbar circuit to ground a core power rail.
